(19) United States
(12) Patent Application Publication
(10) Pub. No.: US 2014/0238958 A1
(43) Pub. Date: Aug. 28, 2014

(54) Systems and methods for material processing using light-emitting diodes

(71) Applicant: ULTRATECH, INC., San Jose, CA (US)

(72) Inventors: Arthur W. Zafiropoulo, Atherton, CA (US); Andrew M. Hawryluk, Los Atros, CA (US)

(73) Assignee: Ultratech, Inc., San Jose, CA (US)

(21) Appl. No.: 13/781,682

(22) Filed: Feb. 28, 2013

(51) Int. Cl. B23K 26/00

(52) U.S. Cl. CPC B23K 26/0066
USPC 219/121.6

(57) ABSTRACT

Systems and methods for processing a material layer supported by a substrate using a light-source assembly that includes LED light sources each formed from an array of LEDs. The material layer is capable of undergoing a photo-process having a temperature-dependent reaction rate. Some of the LEDs emit light of a first wavelength that initiate the photo-process while some of the LEDs emit light of a second wavelength that heats the substrate. The heat from the substrate then heats the material layer, which increases the temperature-dependent reaction rate of the photo-process.

### FIELD

The present disclosure relates to material processing, and in particular to systems and methods for material processing using light-emitting diodes (LEDs).

The entire disclosure of any publication or patent document mentioned herein is incorporated by reference.

### BACKGROUND

There is often a need in the manufacturing of devices such as semiconductor devices to process materials using light. In some instances, the process involves a thermal reaction (thermal process), while in other instances the processes involves a photo-reaction (photo-process), while yet in other instances the processes involves both a thermal reaction and a photo-reaction.

The material being processed can be organic or inorganic. Organic materials are used in semiconductor manufacturing for a variety of applications, such as for anti-refection coatings, as photoresist materials. Organic materials are also used in active layers of various types of electronic devices, such as in OLEDs. Inorganic materials include for example isolating or interlayer dielectrics.

Traditionally, the processing of certain materials in semiconductor manufacturing applications (and particular organic materials) includes low-temperature heating (e.g., to 150° C. or below) for relatively long time periods (e.g., several minutes) using conventional means, such as hot plates. Other annealing techniques for organics are being explored, such as by using light beams, as disclosed for example in U.S. Pat. No. 6,784,017.

It is anticipated that there will be a need for processing both organic and inorganic materials using increasingly higher temperatures and for increasing shorter time durations. There is therefore a need for system and methods that can provide material processing using light for shorter time durations and at higher temperatures than are presently available in the art.

### SUMMARY

An aspect of the disclosure is a material processing system. The system may include a combination of short-wavelength LEDs (e.g., λ_{A}<365 nm) and long-wavelength LEDs (e.g., λ_{B}>400 nm). The material processing system can be used to anneal a GaN device (e.g., a GaN LED under fabrication) to improve its performance by improving the conductivity of its p-type layer. The short-wavelength radiation can be used to activate a photo-process that depends on upon the photon energy (i.e., a photo-process) and that has a temperature-dependent reaction rate, while the long-wavelength radiation can be used to increase the temperature of the underlying substrate, which heats the material layer, thereby increasing the temperature-dependent reaction rate of the photo-process.

Another aspect of the disclosure is a laser material processing system for processing a material layer formed on a substrate. The system has a chuck arranged along a system axis. The chuck has a base and a thermal insulation layer atop the base, wherein the thermal insulation layer is configured to support the substrate. The system also has a LED light-source assembly arranged along the system axis and axially spaced apart from the chuck to define a light-transmission region between the LED light-source assembly and the chuck. The LED light-source assembly comprises an array of LED light sources that reside in a plane that is generally parallel to the substrate, with each LED light source comprising a plurality of LEDs that emit light toward the chuck through the light-transmission region. The LED light-source assembly has a total number N_{LS} of light sources, wherein N_{LS} is in the range 80≦N_{LS}≦800, and wherein the plurality of LEDs consists of first and second LEDs that respectively emit light of wavelength λ_{A}<365 nm and wavelength λ_{B}, wherein 400 nm<λ_{B}<2 μm.

Another aspect of the disclosure is the system as described above, wherein each LED light source includes an m×m array of LEDs, wherein 4≦m≦10.

Another aspect of the disclosure is the system as described above, wherein the LED light-source assembly has a total number N_{LED} of LEDs, wherein N_{LED} is in the range from 5,000≦N_{LED}≦50,000.

Another aspect of the disclosure is the system as described above, further comprising a controller operably connected to the LED light sources and adapted to control an amount of light emitted by the LEDs.

Another aspect of the disclosure is the system as described above, wherein the chuck is rotatable.

Another aspect of the disclosure is the system as described above, further comprising a diffuser arranged adjacent the array of LED light sources, the diffuser configured to diffuse or scatter light from the LEDs.

Another aspect of the disclosure is a method of processing a material layer operably supported by a substrate. The method includes placing the substrate beneath an LED light-source assembly having an array of LED light sources that reside in a plane that is generally parallel to the substrate, with each LED light source comprising a plurality of LEDs that emit light toward the chuck through the free-space light-transmission region, wherein the LED light-source assembly has a total number N_{LS} of light sources, wherein N_{LS} is in the range 80≦N_{LS}≦800, and wherein the plurality of LEDs includes first LEDs and second LEDs that respectively emit light of wavelength λ_{A}<365 nm and λ_{B}>400 nm. The method also includes activating the first LEDs to irradiate the material layer with first LED light to initiate a process in the material layer at a first reaction rate. The method further includes activating the second LEDs to irradiate the substrate through the material layer with second LED light to form a heated substrate. The method also includes heating the material layer using the heated substrate to cause the process to have a second reaction rate greater than the first reaction rate.

Another aspect of the disclosure is the method as described above, wherein the material layer comprises photoresist that has been exposed using a photolithography process.

Another aspect of the disclosure is the method as described above, further including rotating the substrate during the activating of the first and second LEDs, wherein the rotating has a rotation rate of at least 300 RPM.

Another aspect of the disclosure is the method as described above, including passing the first and second LED light through a diffuser to increase an amount of illumination uniformity of the first and second LED light at the material layer.

Another aspect of the disclosure is a method of processing a layer of photoresist operably supported by a substrate and having a temperature-dependent photosensitivity. The method includes disposing the substrate beneath an LED light-source assembly having an array of LED light sources that reside in a plane that is generally parallel to the substrate, with each LED light source comprising a plurality of LEDs that can emit light of wavelength of 400 nm or longer toward the photoresist layer through a light-transmission region, wherein the LED light-source assembly has a total number N_{LS} of light sources, wherein N_{LS} is in the range 80≦N_{LS}≦800. The method also includes irradiating the substrate through the photoresist layer with the LED light for a duration of 2 seconds or less to form a heated substrate having a temperature of less than 450° C. The method further includes heating the photoresist layer using the heated substrate to cause the photoresist to have increased photosensitivity.

Another aspect of the disclosure is the method as described above, further including rotating the substrate during the irradiating of the substrate.

Another aspect of the disclosure is the method as described above, including passing the LED light through a diffuser to increase an amount of illumination uniformity of the LED light at the photoresist layer.

Another aspect of the disclosure is a method of processing a layer of photoresist operably supported by a substrate. The method includes performing a photolithographic exposure of the photoresist layer, thereby forming photoresist features in the photoresist layer. The method also includes irradiating the photoresist layer with first light from a plurality of first LEDs having a first wavelength λ_{A}<365 nm for a duration of 2 seconds or less to photo-activate the photoresist layer.

Another aspect of the disclosure is the method as described above, wherein the photoresist layer has a temperature-dependent reaction rate. The method further includes irradiating the substrate through the photoresist layer for a time of 2 seconds or less with second light from a plurality of second LEDs having a second wavelength λ_{B}>400 nm to heat the substrate to a temperature of no greater than 450° C. The method also includes heating the photoresist layer with heat from the substrate, thereby increasing the temperature-dependent reaction rate of the photoresist layer.

Another aspect of the disclosure is the method as described above, further comprising rotating the substrate at a rate of 300 RPM or greater.

Another aspect of the disclosure is the method as described above, wherein the plurality of first LEDs and second LEDs defines a total number of first and second LEDs of between 5,000 and 50,000.

Another aspect of the disclosure is the method as described above, further comprising passing the first light through a diffuser to cause the first light to have greater uniformity at the photoresist layer than without the diffuser.

Another aspect of the disclosure is the method as described above, further comprising passing the second light through a diffuser to cause the second light to have greater uniformity at the photoresist layer than without the diffuser.

Another aspect of the disclosure is the method as described above, further comprising providing a reactive gas adjacent the substrate surface, and irradiating the substrate with first and second light through the reactive gas, wherein the reactive gas reacts with the photoresist layer.

Another aspect of the disclosure is the method as described above, wherein the reaction with the photoresist layer is an etch process.

Another aspect of the disclosure is the method as described above, wherein the reactive gas includes ozone formed by the at least one of the first and second light reacting with oxygen.

Another aspect of the disclosure is a method of processing a material layer operably supported by a substrate. The method includes irradiating the material layer with first light from a plurality of first LEDs having a first wavelength λ_{A}<365 nm for a duration between 0.1 second and 2 seconds to initiate within the material layer a process that has a temperature-dependent reaction rate.

Another aspect of the disclosure is the method as described above, further comprising irradiating the substrate through the material layer for a time of 2 seconds or less with second light from a plurality of second LEDs having a second wavelength λ_{B}>400 nm to heat the substrate to a temperature of no greater than 450° C., and heating the material layer with heat from the substrate, thereby increasing the temperature-dependent reaction rate of the process of the material layer.

Another aspect of the disclosure is the method as described above, wherein the material layer is a doped layer formed in substrate and having a defect density, and wherein the process comprises releasing trapped hydrogen in the doped layer, thereby reducing the defect density.

Another aspect of the disclosure is the method as described above, wherein the material layer comprises an uncured interlayer dielectric material, and wherein the process comprises releasing volatile compounds from the uncured interlayer dielectric.

Another aspect of the disclosure is a method of processing a material layer operably supported by a substrate and having at least one process with a reaction rate. The method includes irradiating the substrate through the material layer for a time in the range from 0.1 second to 10 seconds with light from a plurality of LEDs having a wavelength λ_{B}>400 nm to heat the substrate to a temperature in the range from 200° C. to 500° C. The method also includes heating the material layer with heat from the substrate, thereby increasing the temperature-dependent reaction rate of the at least one process of the material layer.

Another aspect of the disclosure is the method as described above, where the number of LEDs is in the range from 5,000 to 50,000.

Another aspect of the disclosure is the method as described above, wherein the time is between 0.1 second and 1 second.

Another aspect of the disclosure is the method as described above, wherein the material layer comprises photoresist, and wherein the at least one process includes an acid-activation process and an acid-deactivation process that respectively have first and second temperature-dependent reaction rates, with the first reaction rate being greater than the second reaction rate, and wherein heating the material layer increases the difference between the first and second reaction rates.

Additional features and advantages are set forth in the Detailed Description that follows and in part will be readily apparent to those skilled in the art from the description or recognized by practicing the embodiments as described in the Detailed Description and claims thereof, as well as the appended drawings. It is to be understood that both the foregoing general description and the following Detailed Description are merely exemplary and are intended to provide an overview or framework for understanding the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s) and together with the Detailed Description serve to explain principles and operation of the various embodiments. As such, the disclosure will become more fully understood from the following Detailed Description, taken in conjunction with the accompanying Figures, in which:

FIG. 1 is a schematic diagram of an example LED-based material processing system according to the disclosure for thermally annealing a material layer supported by a substrate;

FIG. 2 is a cross-sectional view of the example LED-based material processing system of FIG. 1;

FIG. 3 is similar to FIG. 2, and shows a cross-section of the example LED-based material processing system wherein the LED light sources emit light having different wavelengths;

FIG. 4A is plan view of an example LED light source that is made up of an array of the same type of LEDs;

FIG. 4B is similar to FIG. 4A, except that the LED light source is made up of two different types of LEDs that emit light at different wavelengths;

FIGS. 5A and 5B are plan (front-on) views of two example LED light source assemblies each made up of an array of LED light sources and that is suitable for annealing a material layer that resides on a substrate;

FIG. 6 is a schematic plot of a reaction rate R_{P} (relative units) vs. inverse temperature T⁻¹ (with the temperate T in ° C.), that illustrates example characteristics of two different temperature-dependent processes P_{A} and P_{B};

FIG. 7 is similar to FIGS. 5A and 5B, except that the LED light source is constituted by a single array of LEDs; and

FIG. 8A is similar to FIG. 1 and shows the LED-based material processing system as including a process chamber that allows for carrying out the annealing of the material layer in a controlled environment; and

FIG. 8B is similar to FIG. 8A, and shows an example embodiment that includes a diffuser disposed between the LED light source assembly and the substrate being irradiated.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute a part of this Detailed Description.

Cartesian coordinates are shown in some of the Figures for the sake of reference and are not intended to be limiting as to direction or orientation.

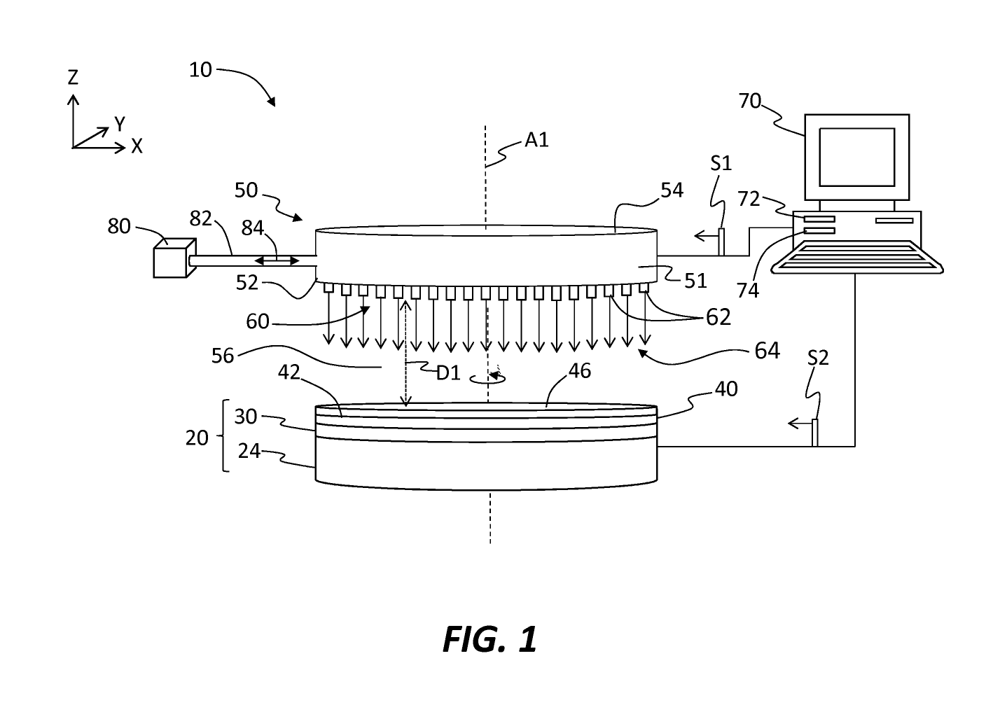

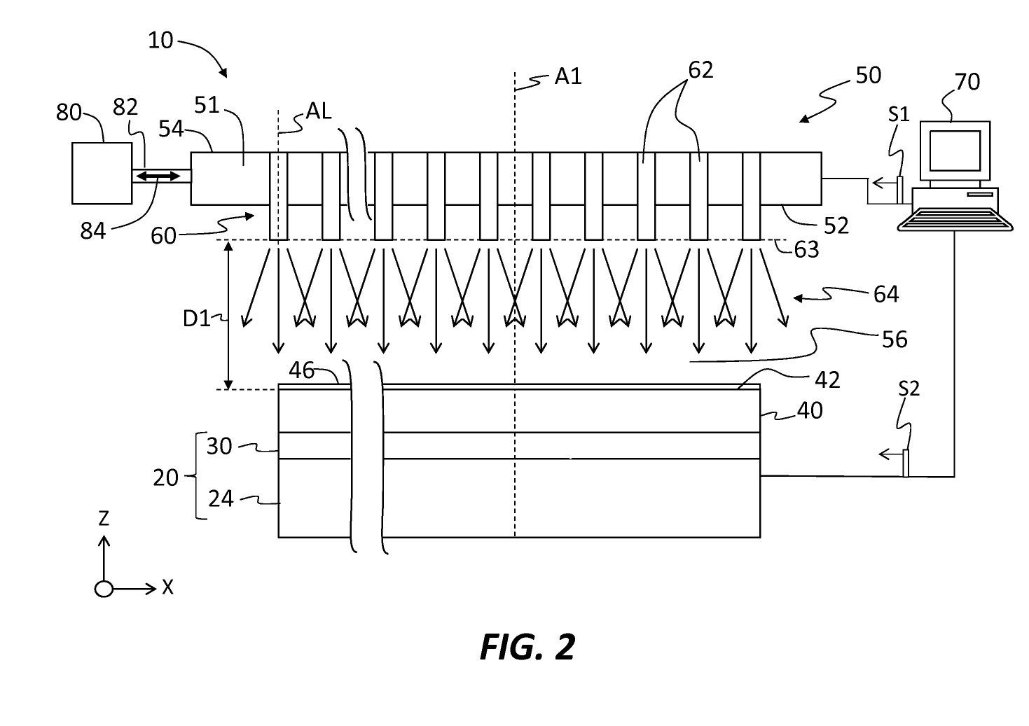

FIG. 1 is an elevated view of an example LED-based material processing system 10, while FIG. 2 is a cross-sectional view of the material processing system taken in the X-Z plane. Material processing system 10 includes a chuck 20 arranged along a vertical system axis A1. Chuck 20 includes a base 24 and thermal isolation layer 30 that resides atop the base. A substrate 40 resides upon thermal isolation layer 30 and has an upper surface 42. Thermal isolation layer 30 serves to keep heat in substrate 40 when the substrate is heated from above, as described below.

At least one layer 46 of material resides upon the substrate upper surface 42. Layer 46 is thus hereinafter referred to as “material layer” 46 even though it may include one layer or multiple layers. Example materials that can make up material layer include organic materials, such as polymers with a carbon atom material layer, anti-reflection coatings materials commonly used in semiconductor lithography applications, and low-k dielectrics commonly used in semiconductor packaging applications, such as SiCOH. Examples of inorganic material for material layer 46 include inorganic dielectrics such as spin-on silicon-dioxide layers. In an example, material layer 46 comprises an interlayer dielectric.

Material processing system 10 can also be used to repair defects in semiconductor devices, such as silicon devices and compound semiconductor devices. For example, in GaN devices, hydrogen is often trapped in the p-type layer, producing traps that reduce conductivity and device performance. Annealing by thermal and photo-activation has been shown to be effective in releasing the hydrogen and improving GaN performance. Thus, in some examples, material layer 46 includes doped portion or region.

In an example, substrate 40 is a semiconductor wafer, e.g., a silicon wafer. In an example, substrate 40 has a diameter in the range from 100 mm (about 4″) to 450 mm (about 18″). However, material processing system 10 can be scaled to process a substrate 40 of any feasible size for use in semiconductor manufacturing.

Material processing system 10 includes an LED light source assembly 50 arranged along axis A1 and spaced apart from substrate 40 by an axial distance D1. An example LED light source assembly 50 includes a support member 51 with a front side 52 and a back side 54, with the front side facing upper surface 42 of substrate 40. LED light source assembly 50 includes an array 60 of LED light sources 62 operably arranged in support member 51. Each LED light source 62 has an LED light source axis AL, which in an example is generally parallel to axis A1. LED light sources 62 are arranged so that they emit light 64 toward substrate 40 and material layer 46 thereon. In an example embodiment, chuck 20 is configured to rotate about axis A1. In an example, LED light sources 62 generally reside in a light source plane 63, which is at or adjacent front side 52 of support member 51. The array 60 of LED light sources 62 and substrate surface 62 are separated by an axial distance D1.

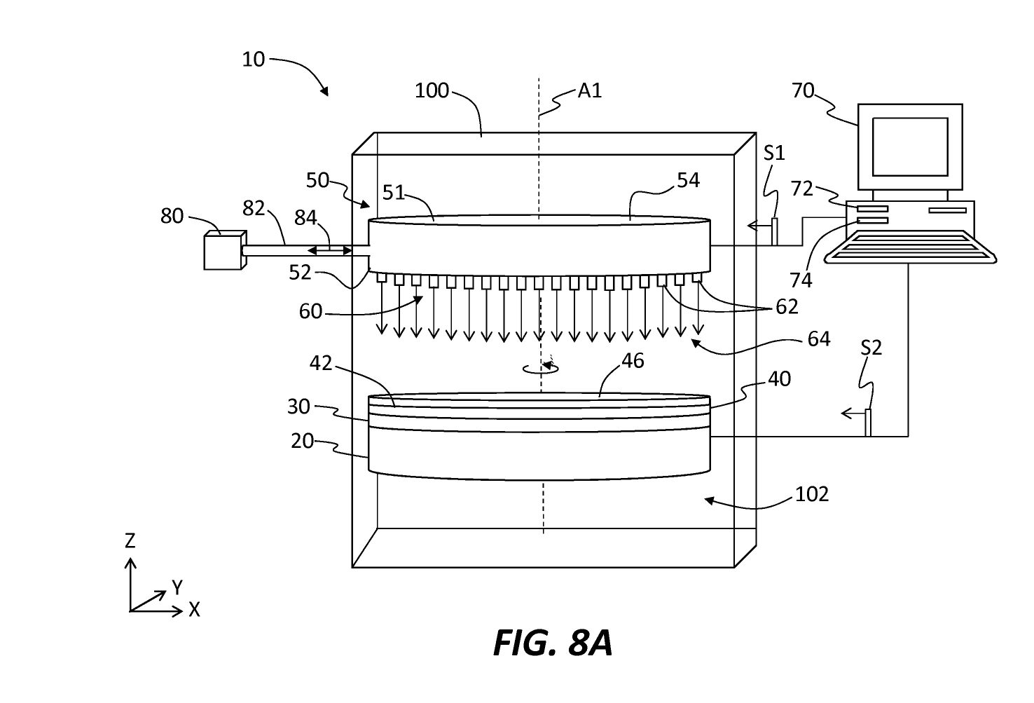

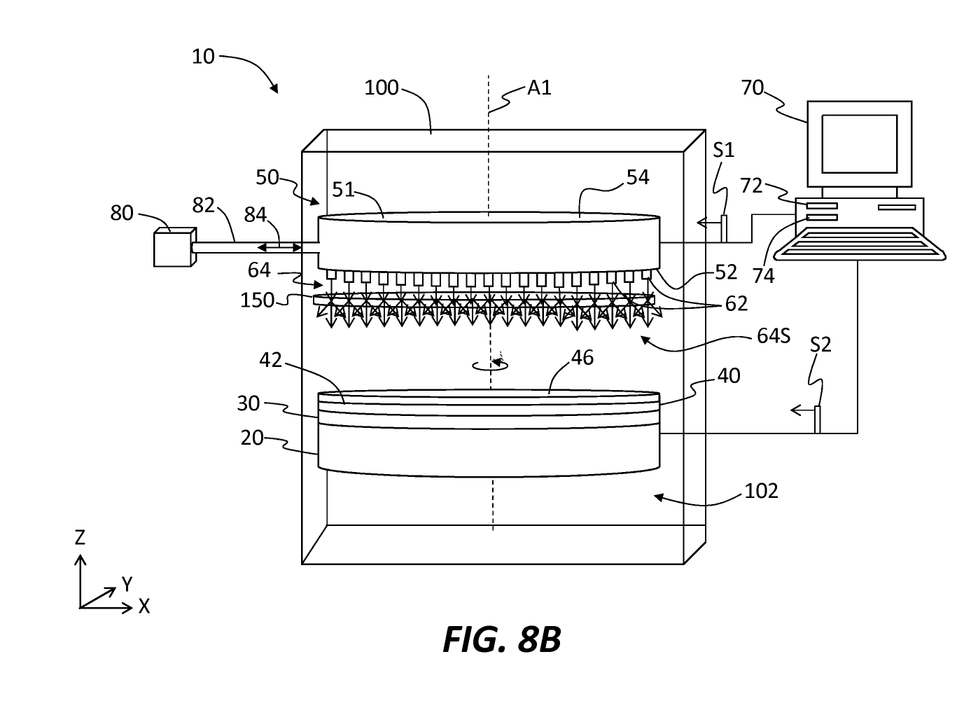

In an example embodiment, the space between light source assembly 50 and material layer 46 of substrate 40 defines a free-space light-transmission region 56 through with light 64 travels from the LED light sources 62 to the material layer without passing through, being reflecting from or being block by any light-transmitting, light reflecting or light-blocking components. In another example, there can be at least one intervening optical component (see component 150 of FIG. 8A), e.g., a light-transmitting, a light reflecting, light scattering, light diffusing, and a light-blocking component, or any combination of such components.

Material processing system 10 also includes a controller 70 operably connected to LED light sources 62 in LED light source array 60 to control the operation of the LED light sources, as well as optionally controlling the rotation of chuck 20 about system axis A1. In an example embodiment, controller 70 is or includes a computer, such as a personal computer or workstation. Controller 70 includes a processor 72, which can be any of a number of commercially available micro-processors, and a memory device (“memory”) 74, as well a suitable bus architecture (not shown) to connect the processor to a memory. Controller 70 can be programmed via instructions (software) embodied in a computer-readable medium (e.g., memory 74, processor 72, or both) that cause the controller to carry out the various functions of material processing system 10 to effectuate annealing of material layer 46 supported by substrate 40. In an example, controller 70 controls the operation of LEDs 62 in LED array 60 with a first control signal S1 and controls the operation of chuck 20 with a second control signal S2.

In an example embodiment, material processing system 10 includes a cooling fluid supply 80 fluidly connected to LED support member 51 via a cooling line 82. Cooling fluid supply 80 supplies a cooling fluid 84 to LED support member 51 and to cooling lines therein (not shown) and also receives the return cooling fluid to remove heat generated by LED light sources 62. Cooling fluid 84 can be any known type of cooling fluid, such as distilled water or a water-glycerin mixture.

FIG. 2 shows an example embodiment where LED light sources 62 are all the same, i.e., each emits light 64 of the same wavelength λ.

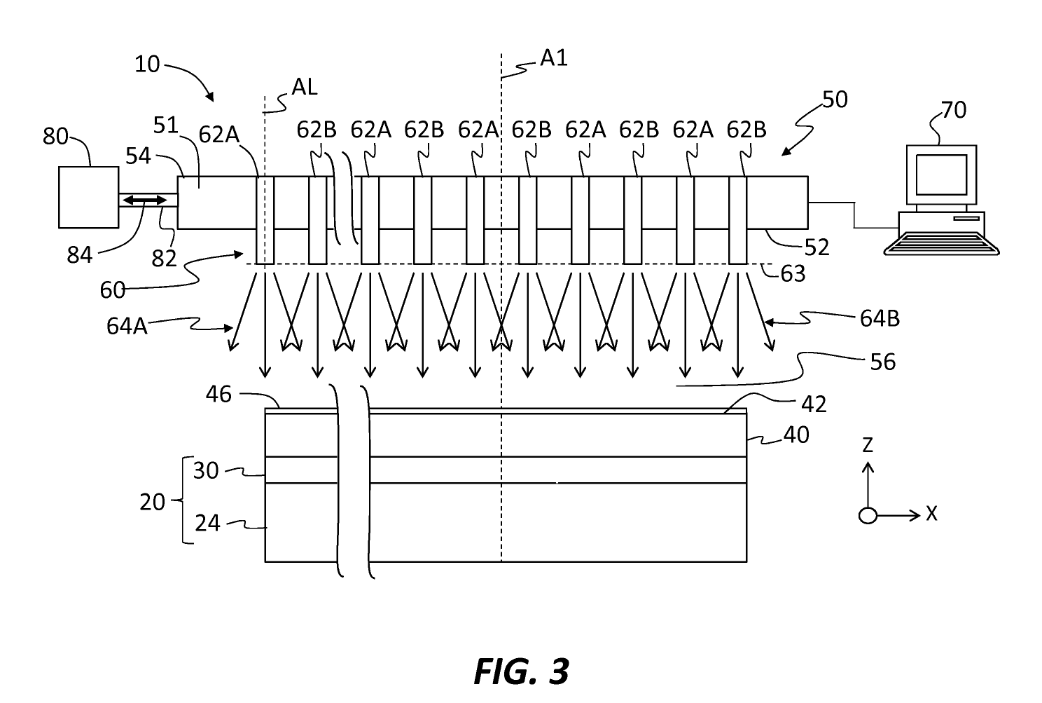

FIG. 3 is similar to FIG. 2 but shows an example wherein LED light source array 60 includes one of two types of LED light sources 62, namely 62A and 62B that emit light 64 at different wavelengths λ_{A} and λ_{B}, respectively.

In an example embodiment, λ_{A} is selected to achieve one effect on material layer 46 while λ_{B} is selected to achieve another effect. For example, λ_{A} can be selected so that it can initiate and drive a photo-process in material layer 46 (e.g., λ_{A} just under 400 nm), while λ_{B} can be another wavelength selected to thermally activate material layer 46 (e.g., λ_{B}>400 nm) or to heat the underlying substrate 40, which in term serves to heat the material layer and increase the reaction rate of the photo-process.

In another example, λ_{A} can be selected so that it can photo-activate a chemical in the ambient atmosphere of material layer 46 while λ_{B} can be selected to heat substrate 40 and thus heat material layer 46. For example, λ_{A} can have a UV wavelength suitable for creating ozone, and the ozone can then interact with the heated material layer 46. This can be used, for example, for enhanced etching of material layer 46.

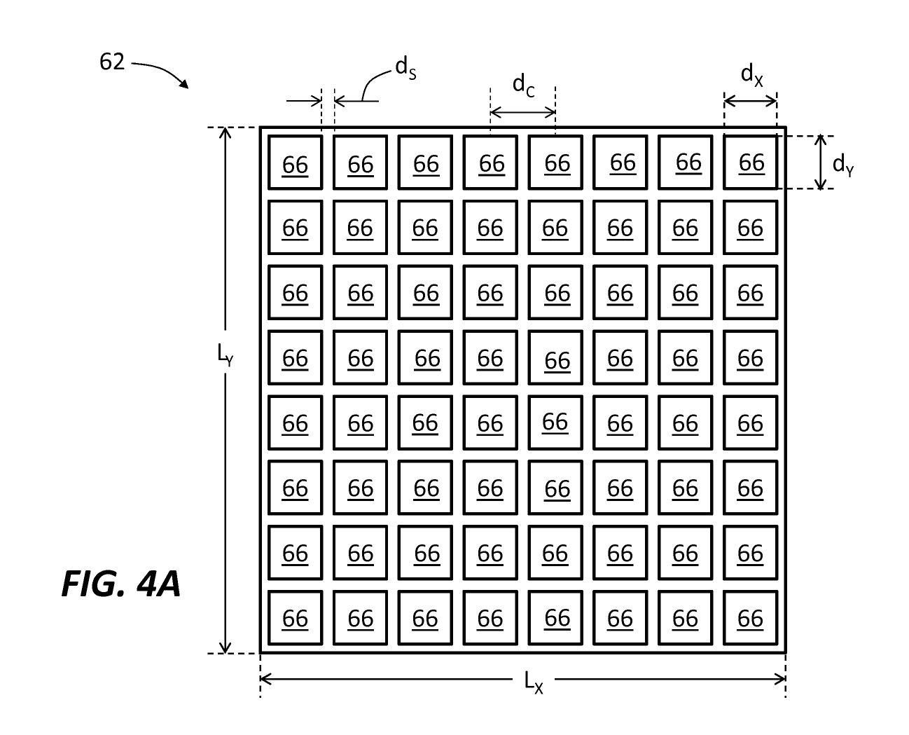

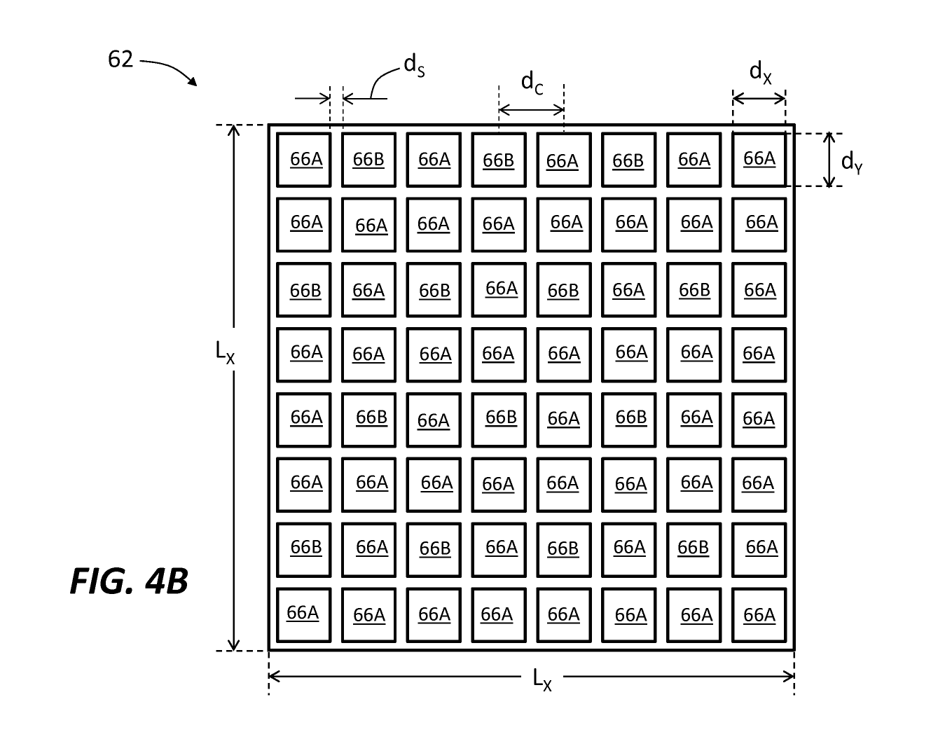

FIG. 4A is a front-on view of an example LED light source 62. In an example embodiment, LED light source 62 is constituted by a sub-array of LEDs 66 that generally lie in a common plane. In an example, LED light source 62 has dimensions L_{X}=1 cm and L_{Y}=1 cm, with each LED 66 having dimensions d_{X}=1 mm and d_{Y}=1 mm, so that the LED light source forms an 8×8 sub-array of sixty-four LEDs 66. In an example, each LED 66 has a Lambertian emission of light 64. LEDs 66 have a center-to-center spacing d_{C} and a distance spacing (e.g., edge-to-edge separation) d_{S}.

FIG. 4B is similar to FIG. 4A but shows an example LED light source 62 that includes different LEDs 66A and 66B that emit light 64A and 64B of different wavelengths λ_{A} and λ_{B}. The number distribution of the different LED light sources 62A and 62B need not be even (e.g., 50% LEDs 62A, 50% LEDs 62B), but can be any ratio or percentage selected to achieve a desired annealing effect on material layer 46.

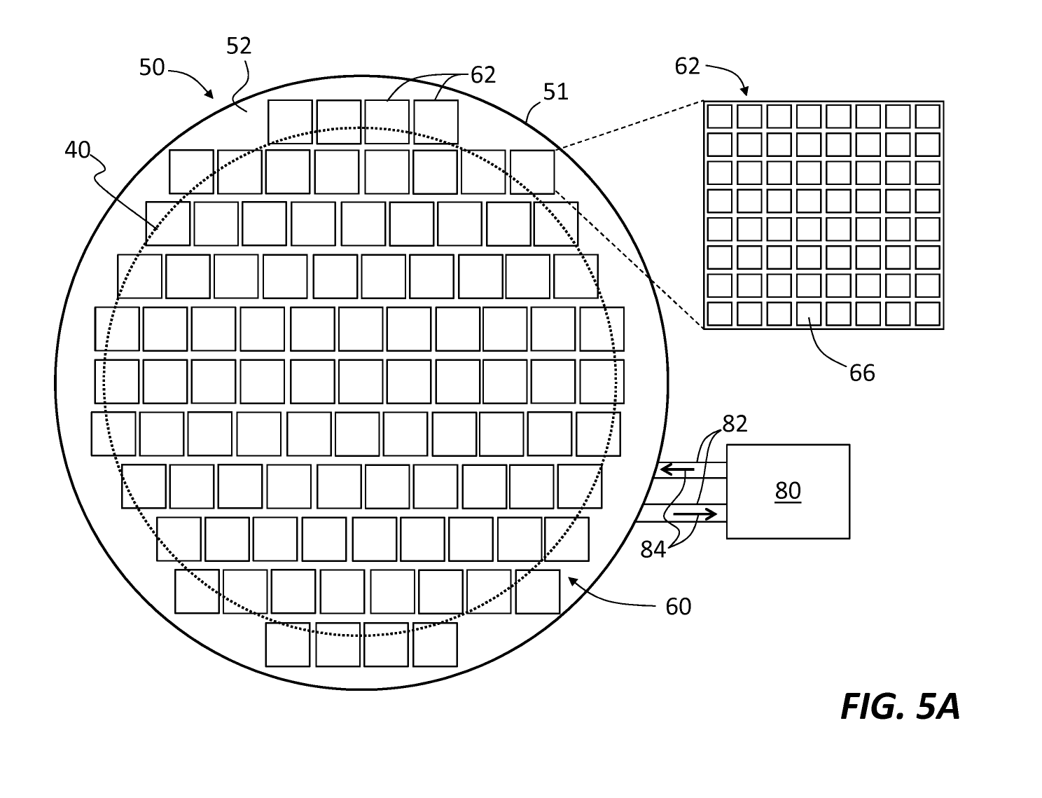

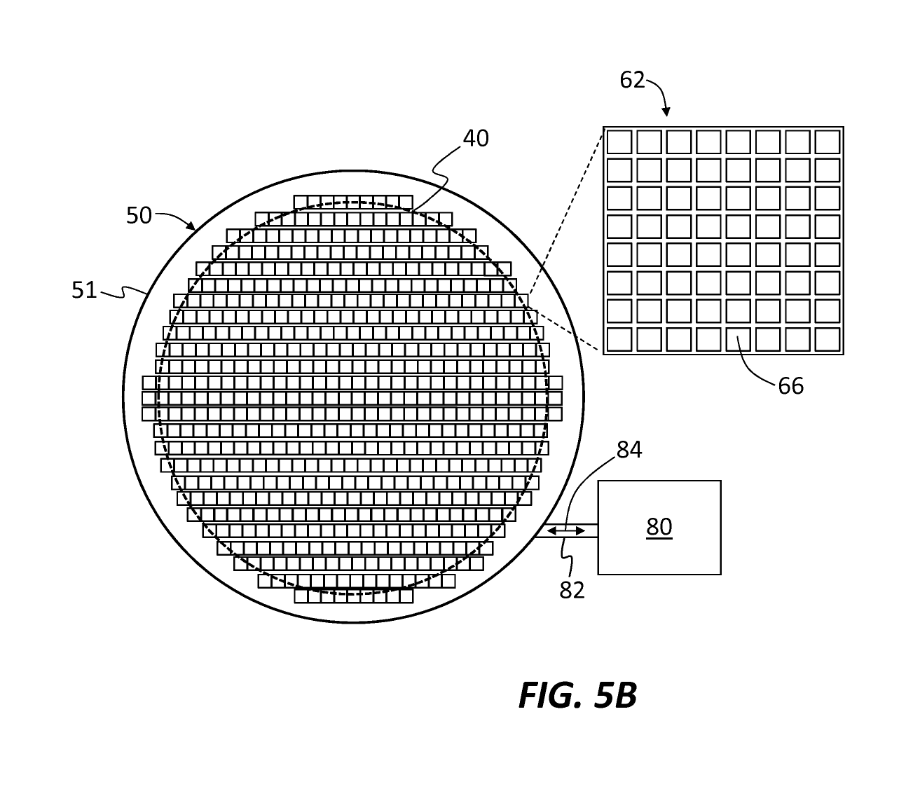

FIG. 5A is a plan (front-on) view of an example LED light source assembly 50 that includes array 60 of spaced apart LED light sources 62, wherein the LED light sources are each constituted by a sub-array of LEDs 66. The outline of substrate 40 is shown as a dotted line and can be for example a 300 mm semiconductor wafer. In an example, LED light sources 62 are the aforementioned example 1 cm×1 cm array of LEDs 66. The example LED light source assembly 50 of FIG. 5A has ninety-three LED light sources 62, with each LED light source having sixty-four LEDs, for a total of five-thousand nine-hundred and fifty-two (5,952) LEDs.

FIG. 5B is similar to FIG. 5A and shows a 300 mm substrate (wafer) 40 and an example LED light source assembly 50 that includes multiple LED light sources 62 each being about 1 cm². LED light sources 62 are configured so that LED light source assembly 50 irradiates the entire substrate surface 42. FIG. 5B is discussed in greater detail below.

In an example embodiment of thermally processing material layer 46, substrate 40 with the material layer therein is arranged on chuck 20 so that the material layer resides beneath LED light source assembly 50. LED light source assembly 50 can have a configuration of LED light sources 60 configured to optimally process material layer 46, e.g., provide an optimum amount of illumination uniformity of light 64. As the emission of light 64 from LEDs 66 is typically Lambertian, it can be modeled to arrive at an optimum (or substantially optimum) illumination distribution at material layer 46. In an example embodiment, substrate 46 is rotated about system axis A1 (e.g., by rotating chuck 20) to further improve illumination uniformity.

Substrate 40 can be rotated by chuck 20 so that multiple rotations of the substrate occur for a given exposure (anneal) time. In an example, substrate 40 rotates at a speed of at least 300 RPM. In another example, substrate 40 rotates at speeds of up to 100 Hz (e.g., 6000 RPM). In an example, substrate 40 rotates as fast as the physical limitations of substrate 40, material layer 46 and chuck 20 will allow. FIG. 5A shows a pair of cooling lines 82 fluidly connecting cooling fluid supply 80 to support member 51 of LED light source assembly 50.

In an example embodiment, controller 70 is configured to control the activation and de-activation of LED light sources 62 or individual LEDs 66. Unlike a hot plate, LEDs 66 can be turned on and off nearly instantaneously. This allows the annealing time and the amount of energy in light 64 to be well controlled.

In addition, the particular LEDs 66 employed in LED light source assembly 50 can be selected to match the processing needs of the particular material layer 46. For example, LEDs 66 can be selected based on the absorption characteristics of an organic material that constitutes material layer 46. Likewise, some organic materials that can constitute material layer 46 may react only to heat, whereas others may react to both heat and light (e.g., photo-chemically).

Because LEDs 66 are narrow-band emitters, a desired wavelength λ (or combinations of wavelengths λ_{A}, λ_{B}, . . . ) of light 64 can be selected to optimize the processing of material layer 46. This is an enhancement over flashlamp light sources because flashlamps are broadband and are not amenable to tailoring their emission to be narrow band to match the absorption characteristics of material layer 46.

In an example, material layer 46 may require a combination of thermal processing and photo-processing, wherein the photo-processing is achieved with exposure to light 64 having a wavelength λ_{A} below 400 nm. An example photo-process is a photo-reaction associating with UV curing. In an example, the photo-process comprises releasing volatile compounds from an uncured material (e.g., an interlayer dielectric).

However, LEDs 66 having a wavelength below 400 nm tends to have relatively low power. Thus, in an example, LED light source assembly 50 can include the aforementioned light sources 66A and 66B that have some LEDs 66 (e.g., LEDs 66A) that emit light 64A at wavelength λ_{A} below 400 nm to initiate the photo-process, and some LEDs (e.g., LEDs 66B) that emit light 64B at wavelength λ_{B} above 400 nm for thermal activation. The thermal processing time constant that can be reached with LEDs 66 is much shorter than what can be achieved with a hot plate. This allows for improved thermal budgets and curing conditions, which is advantageous in semiconductor processing.

In one example, each LED light source 62 includes all of the same type of LEDs 66 (e.g., either LEDs 66A or 66B) as shown in FIGS. 3 and 4A, while in another example, each LED light source includes a mixture of LEDs 66A and 66B, as shown in FIG. 4B. The amount of time t_{A} that the UV-curing LEDs 66A are illuminating material layer 46 can be controlled by controller 70 to be a different amount of time t_{B} for the thermal-activation LEDs 66B.

In an example, material layer 46 is constituted by photoresist, and in a particular example is constituted by a chemically amplified photoresist. It is known that high-temperature annealing for annealing times in the second and sub-second range can be used to enhance the photoresist exposure properties. For example, photoresists can be made to have greater photosensitivity if post-exposure baked at temperatures over 250° C.

The reasons for this enhanced photoresist performance is a subject of ongoing investigation. However, it is understood at a general level that for chemically amplified photoresists, there are two competing processes. One process is an activation process that generates acids (i.e., an acid-activation process) that result in enhanced photosensitivity, and the second process is a de-activation process that limits the generation of acids. In chemically amplified photoresists, when a photon is absorbed, it creates an acid molecule in the photoresist. This acid molecule then “exposes” a nearby photoresist molecule, which in turn, also creates another acid molecule. This process can continue without stopping in the absence of an acid de-activation process. Thus, a de-activation process prevents the secondary generation of acid molecules from avalanching and exposing the entire layer of photoresist. However, the de-activation process also limits the speed (exposure time) of the photoresist.

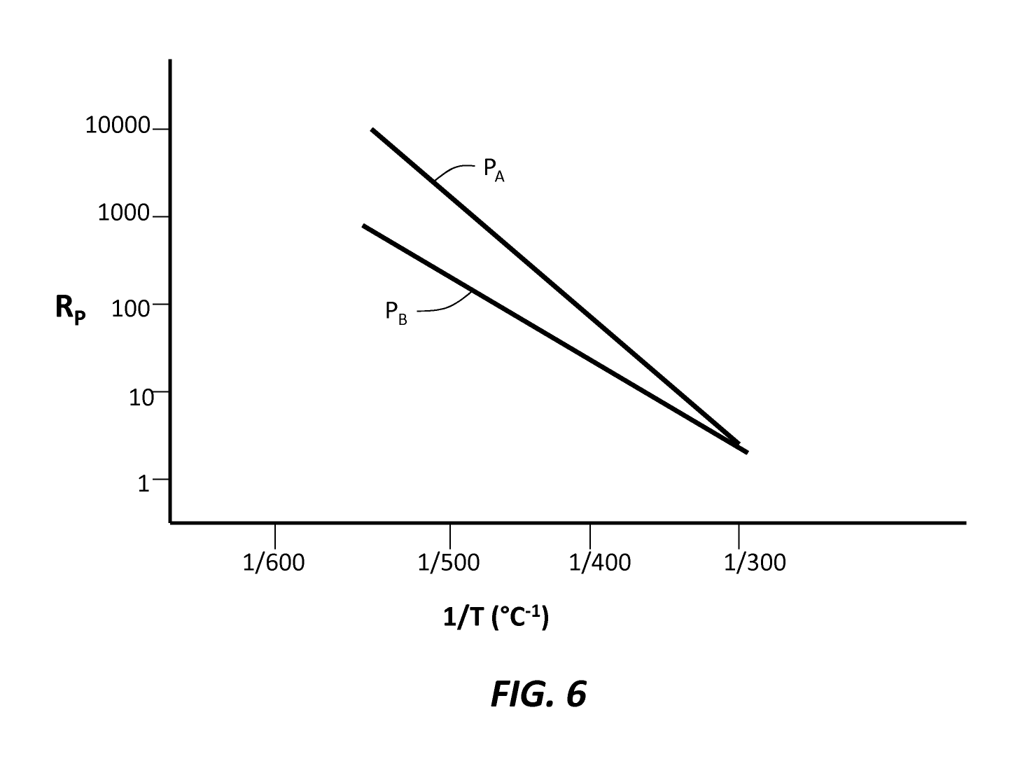

FIG. 6 is a schematic plot of a process reaction rate R_{P} (relative units) vs. inverse temperature T⁻¹, with the temperate T in ° C. The plot illustrates example characteristics of two different temperature-dependent processes P_{A} and P_{B} that can occur in material layer 46. In an example where material layer 46 comprises a chemically amplified photoresist, process P_{A} can represent the acid-activation (or acid-generation) process, and process P_{B} can represent the acid de-activation process. At room temperature, the two processes have somewhat comparable reaction rates, but at higher temperatures, the acid generation process P_{A} has a higher reaction rate than the de-activation process P_{B}. Hence, if the goal is to increase the sensitivity of photoresist layer 46, wafer 40 can be annealed at a higher temperature, thereby creating more acid molecules, and fewer de-activation molecules in the photoresist layer.

In the example of FIG. 6, if the photoresist layer 46 is annealed at a temperature in the range of 400° C. to 500° C. (e.g., 450° C.), an appreciable difference in the reaction rates R_{P} of processes P_{A} and P_{B} can be achieved, with the reaction rate for process P_{A} being substantially higher than that for process P_{B}. However, the reaction rate R_{P} of process P_{A} at these elevated temperatures is 50 to 100 times higher than that at room temperature. Hence, to achieve a fixed amount of acid molecules, the anneal time must be reduced by 50× to 100×. Conventional post-exposure bake processes are typically performed for times ranging from 60 to 120 seconds, which implies that the anneal time (duration) at 400° C. to 500° C. must be reduced to about 1 to 2 seconds.

Thus, an aspect of the disclosure includes annealing a photoresist material layer 46 with an annealing time in the range in one example from about 0.1 second to 10 seconds, and at a temperature in the range from 200° C. to 500° C. In another example, the annealing time is in the range from 0.1 second to 2 seconds, while in another example, the annealing time is in the range from 0.1 second to 1 second.

In an example embodiment, light 64 has a wavelength that is greater than 400 nm to prevent higher-energy photons from interfering with the image-recording properties of the photoresist. For UV activation, in an example, one or more wavelengths of less than 400 nm (e.g., 365 nm or shorter) can be employed whereas for thermal activation, one or more wavelengths greater than 400 nm can be employed.

When photoresist is exposed to form a photoresist pattern, there is a certain amount of roughness to the line edges of the photoresist pattern. This is referred to as “line-edge roughness.” Line-edge roughness can be dramatically reduced by performing a high-temperature anneal of the exposed photoresist (i.e., a post-expose anneal, similar to a post-expose bake, the latter of which implies the use of a bake plate). The line-edge roughness can be reduced by increasing the temperature of the photoresist to the point where it begins to flow. However, it is imperative that the process not cause the line edge itself to flow or degrade.

Reduction of the line-edge roughness can be considered as having two competing processes similar to that described above with respect to photoresist sensitivity. Thus, the graph of FIG. 6 can be applied, wherein process P_{A} is the process reaction rate for which the line-edge roughness decreases, and the second process P_{B} is the process for which the line itself degrades. Each of these processes has a corresponding reaction rate R_{P} (e.g., R_{PA} and R_{PB}) that is a function of temperature T. By increasing the temperature T and reducing the annealing time, the line-edge roughness can be minimized without substantially degrading the line itself.

Thus, the two examples discussed above relating to photoresist sensitivity and line-edge roughness illustrate how the LED light source assembly 50 can be used to carry out annealing of material layer 46 by adjusting the time vs. temperature balance for the given material layer, when the material layer has two competing processes with different reaction rates as a function of temperature.

In an example where substrate 40 is made of silicon (e.g. a silicon wafer) and wherein the annealing times exceed 100 milliseconds (i.e., 0.1 second), the thermal conductivity of silicon ensures that the entire silicon wafer can be heated by light 64. Specifically, an anneal time of 100 milliseconds, the thermal diffusion distance in silicon is approximately 1 mm, which is greater than the thickness of a typical silicon wafer. Hence, the wafer becomes thermally uniform and can be used to uniformly heat material layer 46, and in particular can be used to enhance one or more temperature-dependent thermal processes that occur in the material layer. For light 64 to be absorbed in either photoresist material layer 46 or in the silicon wafer 40, a wavelength λ_{A} in the range between about 400 nm and 2 microns is preferred. For such applications, the amount of energy needed to heat the entire wafer can be determined.

The heat capacity of silicon is roughly 0.7 Joules/(gm-° C.). Raising the temperature of a 300 mm wafer that is 750 microns thick by 100° C. in one second requires that the wafer absorb 8.5 KJ of energy (12 Joules/cm²). LED light source assembly 50 can provide this amount of energy using, e.g., LEDs 66 that emit between 500 mW and 1000 mW from a 1 mm×1 mm package. Such LEDs are commercially available, e.g., from Nichia Corporation, Japan, or from Cree, Inc., Durham, N.C.

As shown in FIGS. 4A and 4B, an example LED light source 62 is constituted by an 8×8 array of LEDs 66, each with a 1 cm×1 cm package. The LEDs 66 are preferably spaced apart to facilitate cooling. Thus, an example of such an LED light source 62 is capable of emitting between 32 to 64 Watts of power in a 1 cm² package. In one second, the LED light source 62 can emit 32 to 64 Joules/cm², which exceed the requirement to raise the example 300 mm silicon wafer by 100° C. The thermal conductivity of silicon serves to improve the temperature uniformity of the annealing of material layer 46.

Thus, in an example, LED light source assembly 50 of FIG. 5A can be used to heat a 100 mm (˜4″) silicon wafer 40 to several hundred ° C. within an annealing time on the order of 1 second or shorter. In an example embodiment, LED light source 62 is constituted by a m×m array of LEDs 66, where in one example m is in the range from 4 to 10, while in another example m is in the range from 6 to 8. The example LED light source 50 of FIG. 5a has 95 light sources 62, each of which includes 64 LEDs 66 (i.e., m=8), so that the example LED light source assembly 50 has about 6,000 LEDs, or more precisely 6,080 LEDs. In another example, LED light source is constituted by a rectangular or linear array n×m array of LEDs 66, where n is 1 or greater and m is in the range from 2 to 10.

FIG. 5B is similar to FIG. 5A and shows a 300 mm wafer 40 and an example LED light source assembly 50 with 1 cm² light sources 62 covering the wafer. The area of a 300 mm wafer is about 706 cm². Assuming that using 1 cm squares to cover this area would require covering about a 10% more area, it would take about 778 light sources 62. If each LED source 62 includes 64 LEDs (i.e., if m=8), then LED light source assembly 50 has about 48,000 LEDs 66 (e.g., 750×64).

Thus, for a substrate (wafer) 40 having a radius R, the number N_{LS} of 1 cm² light sources 62 needed in LED light source assembly 50 is approximated by N_{LS}=(1.1)·π·R² (for R in cm) and the number N_{LED} of LEDs 66 for a given value of m is given by N_{LED}=N_{T}·m². Thus, for substrates 40 in the range from 100 mm to 300 mm, the number N_{LS} can range from about 80 to about 800, and the number N_{LED} of LEDs 66 can range from about 5,000 to about 50,000.

In some photoresist applications, the temperature of the photoresist is increased from room temperature to a processing temperature (i.e., a post-expose-bake temperature). By way of example, when the processing temperature is 400° C. and this is achieved by heating a silicon substrate 40, the substrate needs to absorb about 50 Joules/cm² of energy. The light source assembly 50 can provide this energy in less than 1 second.

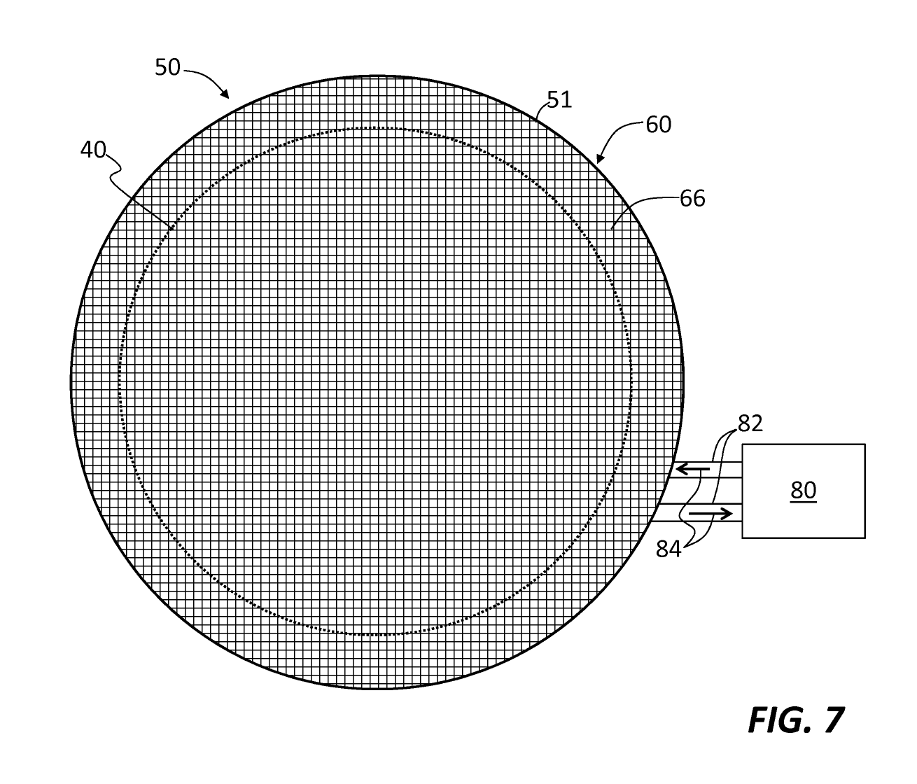

FIG. 7 is similar to FIGS. 5A and 5B and illustrates an example embodiment wherein LED light source assembly 50 includes an array of LEDs 66 rather than multiple arrays 60 of LED light sources 62 that are each constituted by an array of LEDs. The array of LEDs 66 can be thought of as a single large LED light source 62. This particular embodiment of LED light source assembly 50 can provide greater flexibility in terms of the placement of LEDs 66, which can eventually lead to better uniformity of light 64 delivered to material layer 46. The array of LEDs 66 can be constitute by LEDs that emit different wavelengths.

Typical individual LEDs 66 have dimensions of 1 mm×1 mm. In an example, LEDs 66 are spaced apart by a spacing distance d_{S} (i.e., edge-to-edge spacing) of about 200 microns (see FIG. 4A). While a larger spacing distance d_{S} can be employed, a spacing distance greater than the dimensions of the LED will usually lead to a lower illumination uniformity at substrate surface 42 or material layer 46. The emission of light 64 from a given LED 66 is very close to Lambertian. For uniformity reasons, it is therefore desirable to have the Lambertian emission from one LED 66 overlap the emission from its neighbors at material layer 46.

In an example, this overlap can be at about their 1/e intensity points. The intensity overlap condition for adjacent LEDs 66 determines the minimum axial distance D1 between the LEDs 66 and substrate surface 42 or material layer 46 thereon. In an example, the axial distance D1 is about equal to the center-to-center distance d_{C} between the LEDs 66. For a 1 mm square LED 66 with a 200 micron distance spacing d_{S}, the axial distance D1≈1.2 mm=d_{C}. Greater separations can improve illumination uniformity, but can also lead to reduced intensity at material layer 46, which reduces the peak annealing temperature. It is noted that that the uniformity of light (illumination) 64 can also be improved by rotating substrate 40 during annealing, by using a diffuser (see FIG. 8B), or a combination of these approaches

In the above example, the center-to-center distance d_{C} of LEDs 66 in LED light source 60 is roughly 1.2 mm, and the area of each LED is roughly 1.44 mm². In such an example, the number N_{LED} of LEDs 66 for substrate 40 of radius R is approximated by the area of the substrate (in mm²) divided by 1.44.

FIG. 8A is similar to FIG. 1 and illustrates an example embodiment wherein material processing system 10 includes a processing chamber 100 having an interior 102. LED light source assembly 50 and chuck 20 reside in chamber interior 102. This configuration of material processing system 10 allows for thermal annealing of material layer 46 using LED light source assembly 50 to be carried out in a controlled environment formed in chamber interior 102. For example, chamber interior 102 can contain an inert gas (or gases) or a process gas (or gasses).

Thus, as noted above, wavelength λ_{A} can be selected so that it can photo-activate a gas in the ambient atmosphere of material layer 46 while λ_{B} can be selected to heat substrate 40 and thus heat material layer 46. For example, λ_{A} can have a UV wavelength suitable for creating ozone from oxygen, and the ozone can then interact with the heated material layer 46. This can be used, for example, for enhanced etching of material layer 46.

FIG. 8B is similar to FIG. 8A, and shows an example embodiment that includes a diffuser 150 disposed between the LED light source 50 assembly and the substrate 40. Diffuser 150 diffuses or scatters light 64 from light sources 60 and forms scattered or diffused light 64S. Diffuser 150 thus serves to uniformized light 64 at substrate surface 46 or at material layer 46 residing thereon.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

1. A laser material processing system for processing a material layer formed on a substrate, comprising:
a chuck arranged along a system axis and having a base and a thermal insulation layer atop the base, wherein the thermal insulation layer is configured to support the substrate;
a light-emitting diode (LED) light-source assembly arranged along the system axis and axially spaced apart from the chuck to define a light-transmission region between the LED light-source assembly and the chuck, wherein the LED light-source assembly comprises an array of LED light sources that reside in a plane that is generally parallel to the substrate, with each LED light source comprising a plurality of LEDs that emit light toward the chuck through the light-transmission region; and
wherein the LED light-source assembly has a total number N_{LS} of LED light sources, wherein N_{LS} is in the range 80≦N_{LS}≦800, and wherein the plurality of LEDs consists of first and second LEDs that respectively emit light of wavelength λ_{A}<365 nm and wavelength λ_{B}, wherein 400 nm<λ_{B}<2 μm.

2. The system according to claim 1, wherein each LED light source includes an m×m array of LEDs, wherein 4≦m≦10.

3. The system according to claim 1, wherein the LED light-source assembly has a total number N_{LED} of LEDs, wherein N_{LED} is in the range from 5,000≦N_{LED}≦50,000.

4. The system according to claim 1, further comprising a controller operably connected to the LED light sources and adapted to control an amount of light emitted by the LEDs.

5. The system according to claim 1, wherein the chuck is rotatable.

6. The system according to claim 1, further comprising a diffuser arranged adjacent the array of LED light sources, the diffuser configured to diffuse or scatter light from the LEDs.

7. A method of processing a material layer operably supported by a substrate, comprising:
placing the substrate beneath an LED light-source assembly having an array of LED light sources that reside in a plane that is generally parallel to the substrate, with each LED light source comprising a plurality of LEDs that emit light toward the material layer through the free-space light-transmission region between the LED light sources and the material layer, wherein the LED light-source assembly has a total number N_{LS} of light sources, wherein N_{LS} is in the range 80≦N_{LS}≦800, and wherein the plurality of LEDs includes first LEDs and second LEDs that respectively emit light of wavelength λ_{A}<365 nm and λ_{B}>400 nm;
activating the first LEDs to irradiate the material layer with first LED light to initiate a process in the material layer at a first reaction rate; and
activating the second LEDs to irradiate the substrate through the material layer with second LED light to form a heated substrate; and
heating the material layer using the heated substrate to cause the process to have a second reaction rate greater than the first reaction rate.

8. The method according to claim 7, wherein the material layer comprises photoresist that has been exposed using a photolithography process.

9. The method according to claim 7, further including rotating the substrate during the activating of the first and second LEDs, wherein the rotating has a rotation rate of at least 300 RPM.

10. The method according to claim 7, including passing the first and second LED light through a diffuser to increase an amount of illumination uniformity of the first and second LED light at the material layer.

11. A method of processing a layer of photoresist operably supported by a substrate and having a temperature-dependent photosensitivity, comprising:
disposing the substrate beneath an LED light-source assembly having an array of LED light sources that reside in a plane that is generally parallel to the substrate, with each LED light source comprising a plurality of LEDs that can emit light of wavelength of 400 nm or longer toward the photoresist layer through a light-transmission region, wherein the LED light-source assembly has a total number N_{LS} of LED light sources, wherein N_{LS} is in the range 80≦N_{LS}≦800;
irradiating the substrate through the photoresist layer with the LED light for a duration of 2 seconds or less to form a heated substrate having a temperature of less than 450° C.; and
heating the photoresist layer using the heated substrate to cause the photoresist to have increased photosensitivity.

12. The method according to claim 11, further including rotating the substrate during the irradiating of the substrate.

13. The method according to claim 11, including passing the LED light through a diffuser to increase an amount of illumination uniformity of the LED light at the photoresist layer.

14. A method of processing a layer of photoresist operably supported by a substrate, comprising:
performing a photolithographic exposure of the photoresist layer, thereby forming photoresist features in the photoresist layer; and
irradiating the photoresist layer with first light from a plurality of first LEDs having a first wavelength λ_{A}<365 nm for a duration of 2 seconds or less to photo-activate the photoresist layer.

15. The method according to claim 14, wherein the photoresist layer has a temperature-dependent reaction rate, and further comprising:
irradiating the substrate through the photoresist layer for a time of 2 seconds or less with second light from a plurality of second LEDs having a second wavelength λ_{B}>400 nm to heat the substrate to a temperature of no greater than 450° C.; and
heating the photoresist layer with heat from the substrate, thereby increasing the temperature-dependent reaction rate of the photoresist layer.

16. The method according to claim 15, further comprising rotating the substrate at a rate of 300 RPM or greater.

17. The method according to claim 15, wherein the plurality of first LEDs and second LEDs defines a total number of first and second LEDs of between 5,000 and 50,000.

18. The method according to claim 15, further comprising passing the first light through a diffuser to cause the first light to have greater uniformity at the photoresist layer than without the diffuser.

19. The method according to claim 15, further comprising passing the second light through a diffuser to cause the second light to have greater uniformity at the photoresist layer than without the diffuser.

20. The method according to claim 15, further comprising:
providing a reactive gas adjacent the substrate surface; and
irradiating the substrate with first and second light through the reactive gas, wherein the reactive gas reacts with the photoresist layer.

21. The method according to claim 20, wherein the reaction with the photoresist layer is an etch process.

22. The method according to claim 21, wherein the reactive gas includes ozone formed by the at least one of the first and second light reacting with oxygen.

23. method of processing a material layer operably supported by a substrate, comprising:
irradiating the material layer with first light from a plurality of first LEDs having a first wavelength λ_{A}<365 nm for a duration between 0.1 second and 2 seconds to initiate within the material layer a process that has a temperature-dependent reaction rate.

24. The method according to claim 23, further comprising:
irradiating the substrate through the material layer for a time of 2 seconds or less with second light from a plurality of second LEDs having a second wavelength λ_{B}>400 nm to heat the substrate to a temperature of no greater than 450° C.; and
heating the material layer with heat from the substrate, thereby increasing the temperature-dependent reaction rate of the process of the material layer.

25. The method according to claim 24, wherein the material layer is a doped layer formed in substrate and having a defect density, and wherein the process comprises releasing trapped hydrogen in the doped layer, thereby reducing the defect density.

26. The method according to claim 24, wherein the material layer comprises an uncured interlayer dielectric material, and wherein the process comprises releasing volatile compounds from the uncured interlayer dielectric material.

27. A method of processing a material layer operably supported by a substrate and having at least one process with a reaction rate, comprising:
irradiating the substrate through the material layer for a time in the range from 0.1 second to 10 seconds with light from a plurality of LEDs having a wavelength λ_{B}>400 nm to heat the substrate to a temperature in the range from 200° C. to 500° C.; and
heating the material layer with heat from the substrate, thereby increasing the temperature-dependent reaction rate of the at least one process of the material layer.

28. The method of claim 27, where the number of LEDs is in the range from 5,000 to 50,000.

29. The method of claim 27, wherein the time is between 0.1 second and 1 second.

30. The method of claim 27, wherein the material layer comprises photoresist, and wherein the at least one process includes an acid-activation process and an acid-deactivation process that respectively have first and second temperature-dependent reaction rates with the first temperature-dependent reaction rate being greater than the second temperature-dependent reaction rate, and wherein heating the material layer increases the difference between the first and second temperature-dependent reaction rates.
